(19) United States
(12) Patent Application Publication
(10) Pub. No.: US 2026/0244062 A1
(43) Pub. Date: Aug. 20, 2026

(54) Variable optical-property interlayer product and method for manufacturing a variable optical-property interlayer product

(71) Applicant: CHROMOGENICS AB, Uppsala (SE)

(72) Inventor: Greger Gregard, Uppsala (SE)

(21) Appl. No.: 19/156,240

(22) PCT Filed: Feb. 13, 2024
(86) PCT No.: PCT/SE2024/050126

§ 371 Date: Aug. 13, 2025

(30) Foreign Application Priority Data
Feb. 14, 2023 (SE) 2350137-2

(51) Int. Cl. G02F 1/153; G02F 1/1333; G02F 1/1514

(52) U.S. Cl. CPC G02F 1/1533; G02F 1/133305; G02F 1/1514

(57) ABSTRACT

A method for producing a variable optical-property interlayer product comprises providing (S10) of a variable optical-property film The variable optical-property film is placed (S30) on top of a first lamination interlayer film of a lamination inter-layer material. A second lamination interlayer film of a lamination interlayer material is positioned (S50) as to cover the variable optical-property film, thereby forming a stack. The stack is laminated (S90), forming a polymer envelope, gas-tightly encapsulating the electrochromic film. The lamination forms an outer surface of the polymer envelope as a solid/gas interface. A variable optical-property interlayer product and a packaged variable optical-property interlayer product are also disclosed.

WO

### TECHNICAL FIELD

The present invention relates in general to production of laminated glass and in particular to an interlayer product comprising variable optical-property films and a manufacturing method therefore.

### BACKGROUND

Glass products exhibiting different types of light influencing effects have been produced for many years. Electrochromic layers, thermochromic layers, photochromic layers, PDLC-films, SPD-films, LCD-films etc. provided at the outside of a glass pane or between glass panes gives the possibility to control the light transmission through the glass. This enables many different types of light and temperature controlling applications. These layers of variable optical properties may be produced directly onto the glass panes. Alternatively, the layers of variable optical properties may be provided as self-carrying films that subsequently are attached to or between glass panes.

One example of a very well operating electrochromic glass pane product was presented in the European patent EP 3 011 388 B1. A solid-electrochromic-layer layered polymer-based structure was laminated between a first glass pane and a second glass pane, with a respective interlayer film between each side of the solid-electrochromic-layer layered polymer-based structure and the first glass pane and the second glass pane, respectively, forming a stack.

A facility enabling such a production, at least for large areas products, typically need large-area sputter apparatuses and devices for high-precision contacting of solid-electrochromic-layer layered polymer-based structures. Today, general glass manufacturers indeed have large-area lamination facilities, but investments in large-area sputters and other specialized equipment for producing and/or handling films with variable optical properties, such as solid-electrochromic-layer layered polymer-based structures are typically too large compared to the present market demands. Solid-electrochromic-layer layered polymer-based structures may be provided as rollable films, however, careless transporting, handling and/or cutting of such films may easily introduce defects. Therefore, the processing today is instead performed at the sites producing the solid-electrochromic-layer layered polymer-based structures, which calls for transports of heavy glass panes, first to the electrochromic film producer and then further to producers of insulating glass units before it is delivered to the final customer.

In the published US patent application US 2022/072828 A1, a pre-assembly electrically controllable functional element with protective film is disclosed. The functional element includes a multilayer film, comprising, a first protective film, a first carrier film, a first flat electrode, an active layer, a second flat electrode, a second carrier film, and a second protective film. The protective films are a PVB film, an EVA film, and/or a TPU film. The functional element also includes one or more sealing films that are attached to the multilayer film.

It is therefore a need for reducing the amount of heavy transports in such manufacturing chains.

### SUMMARY

A general object of the present technology is to find devices and methods enabling a more cost-efficient and reliable manufacturing of glass products comprising variable optical-property films.

The above object is achieved by methods and devices according to the independent claims. Preferred embodiments are defined in dependent claims. In general words, in a first aspect, a method for producing a variable optical-property interlayer product comprises providing of a variable optical-property film. The variable optical-property film is placed on top of a first lamination interlayer film of a lamination interlayer material. A second lamination interlayer film of a lamination interlayer material is positioned as to cover the variable optical-property film, thereby forming a stack. The stack is laminated forming a polymer envelope. The polymer envelope gas-tightly encapsulates the variable optical-property film. The lamination forms an outer surface of the polymer envelope as a solid/gas interface.

In a second aspect, a variable optical-property interlayer product comprises a variable optical-property film and a polymer envelope. The polymer envelope gas-tightly encapsulates the variable optical-property film. The polymer envelope consists of a lamination interlayer material. An outer surface of the polymer envelope is a solid/gas interface.

In a third aspect, a packaged variable optical-property interlayer product comprises a variable optical-property interlayer product according to the second aspect and a vacuum bagging film at least partly enclosing the variable optical-property interlayer product.

One advantage with the proposed technology is that an intermediate product comprising the variable optical-property parts of a variable optical-property glass product is produced, which is easily transported and handled in a final glass lamination process. Other advantages will be appreciated when reading the detailed description.

### BRIEF DESCRIPTION OF THE DRAWINGS

The invention, together with further objects and advantages thereof, may best be understood by making reference to the following description taken together with the accompanying drawings, in which:

FIG. 1 is a flow diagram of steps of an embodiment of a method for producing a variable optical-property interlayer product;

FIG. 2 is a flow diagram of steps of an embodiment of a method for producing a glass laminate from a variable optical-property interlayer product;

FIGS. 3A-E are schematic illustrations of different phases in an embodiment of the process of producing a variable optical-property interlayer product;

FIGS. 4A-B illustrates schematically the result of an embodiment of a lamination process;

FIGS. 5A-B illustrates schematically the result of another embodiment of a lamination process;

FIGS. 6A-B illustrates schematically the result of yet another embodiment of lamination process;

FIG. 7 illustrates schematically layers in an embodiment of an electrochromic film that can be used in the present technology;

FIG. 8 illustrates schematically an embodiment of a positioning of connectors to a variable optical-property film;

FIG. 9 illustrates schematically another embodiment of a positioning of connectors to a variable optical-property film; and

FIG. 10 is a flow diagram of steps of another embodiment of a method for producing a interlayer product.

### DETAILED DESCRIPTION

Throughout the drawings, the same reference numbers are used for similar or corresponding elements.

For a better understanding of the proposed technology, it may be useful to begin with a brief overview of the production challenges today.

There are today two basic approaches for production logistics. If electrochromic films are used as a model system, in a first option, the electrochromic film is produced in a facility. The electrochromic films are provided in suitable sizes and shapes and are contacted by electrical connections. Heavy glass panes are transported from the glass processing sites, which may not be situated anywhere nearby. The electrochromic films are laminated between the glass panes using interlayer material as lamination adherence material. The glass panes are typically of hardened glass, which means that they have to be provided in the correct size and shape, and have typically to be ordered long time in advance. Breakage of glass panes and/or other processing failures may occur, which means that spare glass panes have to be available if the delivery times for the final products should be guaranteed. This leads to further heavier transports and a lot of remaining broken or non-broken glass panes that only will go directly to disposal or recycling.

In another option, the electrochromic films are provided in rolls and transported to a glass processing facility. At this facility, the electrochromic films are cut into suitable sizes and shapes and are provided with electrical connections. This work has to be performed in cleanroom environment and requires extensive experience with such types of material and equipment that is relatively expensive. The electrochromic films are also relatively sensitive for damages and have to be handled with extreme care. The electrochromic films then have to be placed between glass panes and interlayer materials and sealed in a proper manner. This is also a non-trivial operation, which is far from what normally is performed at glass manufacturer facilities. This approach has proven to be very difficult to be efficient.

It has, however, been discovered that the lamination interlayer materials, for instance Polyvinyl butyral (PVB), have interesting properties. Lamination of glass panes with PVB is typically taken place at temperatures between 120-140° C. The PVB thereby adheres to the glass pane, forming a strong sealing solid/solid interface.

However, at lower temperatures, when adhesion to other materials is not present or at least reduced, adhesion to other PVB objects may anyway occur. Different PVB objects may therefore be attached to each other without forming any strong adhesion to any other material outside. This opens for forming an envelope of PVB that may gas-tightly encapsulating the electrochromic film. The outer surface of the PVB envelope may still have properties that are similar to unlaminated PVB and provides thereby a solid/gas interface that may be suitable for transportation. The PVB envelope can therefore in a first stage be used as a transportation protection for the electrochromic film. In a next stage, the PVB can be used according to its originally intended role, as a lamination interlayer material. This double function of the PVB material, first as a transport coverage and then as a lamination interlayer, facilitates manufacturing considerably.

At a manufacturing plant for electrochromic films, electrochromic films of requested composition, size and shape are produced. Contacting of the electrochromic film can be made in any suitable manner during or in connection with the manufacturing. When the electrochromic films are ready, they may then be encapsulated in a lamination interlayer material, for instance PVB, functioning as a transportation envelope. Transportation can then be performed to a glass manufacturing site in a safe manner. An electrochromic film as such is typically relatively sensitive for handling and it is for instance easy to create sharp folds. Such sharp fold may destroy or significantly affect the electrochromic function. By encapsulating the electrochromic films into an envelope, the risks for sharp folds are considerably reduced. At the glass manufacturing site, the PVB envelope with its encapsulated electrochromic film may be placed between glass panes and laminated. Since the electrochromic film is ready and the lamination interlayer already is in place, this can be performed with standard equipment and operations. The encapsulated electrochromic film thus constitutes a semi-finished product that becomes of interest also to be sold as such. Similar discussions can also be made for other types of variable optical-property devices comprising variable optical-property films compatible with lamination processes.

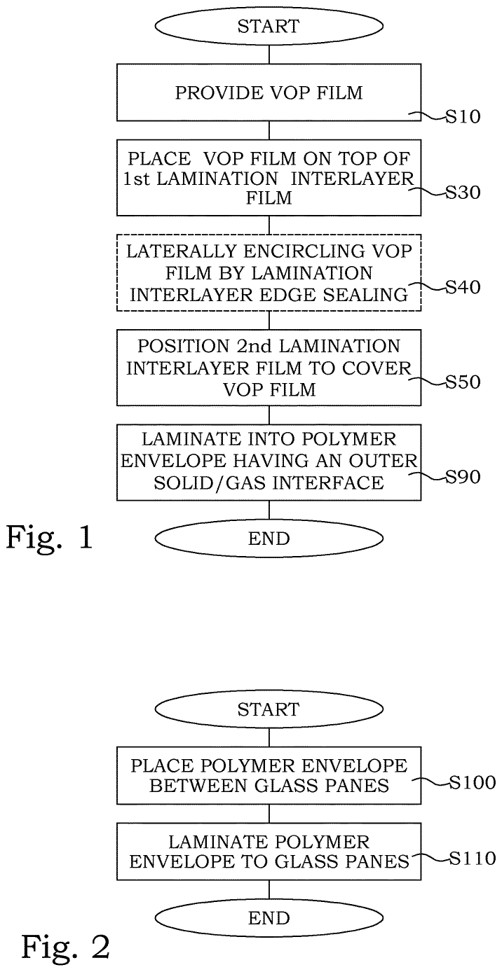

FIG. 1 is a flow diagram of steps of an embodiment of a method for producing a variable optical-property interlayer product. In step S10, a variable optical-property (VOP) film is provided. In step S30, the VOP film is placed on top of a first lamination interlayer film of a lamination interlayer material.

In a preferred embodiment, in step S40, the VOP film is laterally encircled by a lamination interlayer edge sealing of a lamination interlayer material. The VOP film is thereby covered from below by the first lamination interlayer film and sidewards by the lamination interlayer edge sealing.

In step S50, a second lamination interlayer film of a lamination interlayer material is positioned to cover the VOP film. A stack is thereby formed. In step S90, the stack is laminated, forming a polymer envelope. The polymer envelope gas-tightly encapsulates the VOP film. The step of laminating S90 forms an outer surface of the polymer envelope as a solid/gas interface.

In the preferred embodiment, presenting the laterally encircling step S40, between the placing step S30 and the positioning step S50, the polymer envelope is formed by the first lamination interlayer film, the second lamination interlayer film and the lamination interlayer edge sealing. However, the main purpose of the lamination interlayer edge sealing is to provide a thickness compensation so that the thickness of the polymer envelope becomes as uniform as possible over the entire VOP film area.

The so formed variable optical-property interlayer product, comprising the VOP film encapsulated by the polymer envelope, can be stored, transported and/or further used for, for instance, lamination purposes. FIG. 2 presents a flow diagram of steps of an embodiment of a glass lamination process using such variable optical-property interlayer product. In step S100, the polymer envelope, and the therein encapsulated VOP film, is placed between glass panes. In step S110, the glass panes and the envelope are laminated. Such laminations can be performed according to any glass lamination process used for ordinary laminated glass processing, known as such in prior art, without any special tools or preparing procedures adapted to this particular variable optical-property interlayer product.

The lamination interlayer material may be any material that is suitable to be used as interlayers in lamination processes. Examples of materials that can be used in this way are e.g.: Polyvinyl butyral (PVB), Ethylene Vinyl Acetate (EVA), Polyolefin, Thermoplastic polyurethane (TPU), and Ionoplasts. Ionoplast interlayers, also known as ionomer-based interlayers, are available in different compositions. The most used type is SentryGlass®. Extensive tests have been performed by using PVB, which presently is considered as the preferred choice. However, also the other examples presented here above are possible to use, at least with adaptation of the lamination temperatures.

Traditionally, the main task for a lamination interlayer material is to adhere to other materials at both sides of the lamination interlayer, thereby creating a strong bond between these materials. Thereby, after lamination, a strong solid/solid interface is provided on both sides of the lamination interlayer.

In the processes presented here, the use of the lamination interlayer is extended. First, the lamination properties of the lamination interlayer are used, but only partly, in order to provide the polymer envelope that encapsulates the VOP film. This is preferably caused by, during the step of laminating, exposing the lamination interlayer material for a temperature causing intra-lamination between the different lamination interlayer material pieces. The polymer envelope may, in other embodiments, be formed at least partly by other adhesion enhancing processes.

As mentioned above, in ordinary lamination processes, the lamination interlayer material forms solid/solid interfaces with the surrounding materials. However, in this application, it is instead of importance that the outer surface of the polymer envelope, i.e. the outer surface of the lamination interlayer material, is a solid/gas interface.

It is also of interest that the lamination properties of the outer surface are preserved, as far as possible. If cross-binding lamination interlayer materials, such as e.g. EVA, are used, it is therefore preferred to restrict the lamination temperature to a range safely below the cross-binding temperatures for the lamination interlayer materials. A typical cross-binding temperature for EVA is around 120° C., and the lamination temperature for creating the polymer envelope may e.g. be set to maximum 100° C.

For lamination interlayer materials not exhibiting cross-binding properties, the lamination conditions may be selected more freely. However, since lamination interlayer materials typically are provided having certain surface structures that will be advantageous in ordinary lamination processes, it is preferred to, as far as possible, maintain such structures on the polymer envelope surface. This will be beneficious for subsequent glass lamination processes. To that end, in a preferred embodiment, the step of laminating is performed at a temperature leaving the outer surface of the polymer envelope structurally unchanged.

In an alternative embodiment, if the lamination temperature is allowed to be so high that the surface structures are changed, external surfaces having a suitable structure may be pressed against the polymer envelope during the lamination in order to impose its structure to the outer surface of the envelope. In tests, lamination has been performed at a temperature below 70° C., exhibiting good results, both in intra-adhesion between different pieces of lamination interlayer material as well as in preserving outer surface structures. The optimum choice of temperature will depend on which lamination interlayer material that is selected. However, it should be noticed that lamination also at higher temperatures will result in variable optical-property interlayer products that are advantageous for later glass lamination processes as well, even if the higher temperatures as such do not generally improve the final result. At the present, it is believed that the lamination temperature advantageously can be kept below 100° C. for most lamination interlayer materials. A lower temperature saves generally energy and heating time, and in a preferred embodiment, the lamination temperature is kept below 80° C.

The lower limit for the lamination does also depend on the available processing time. Lamination at lower temperatures generally require longer process times. Using EVA at a lamination temperature of 50° C. will be possible if a long exposure is used.

In other words, in a preferred embodiment, the step of laminating is performed in a temperature interval between 50° C. and 100° C., more preferably at a temperature below 80° C., and most preferably at a temperature below 70° C.

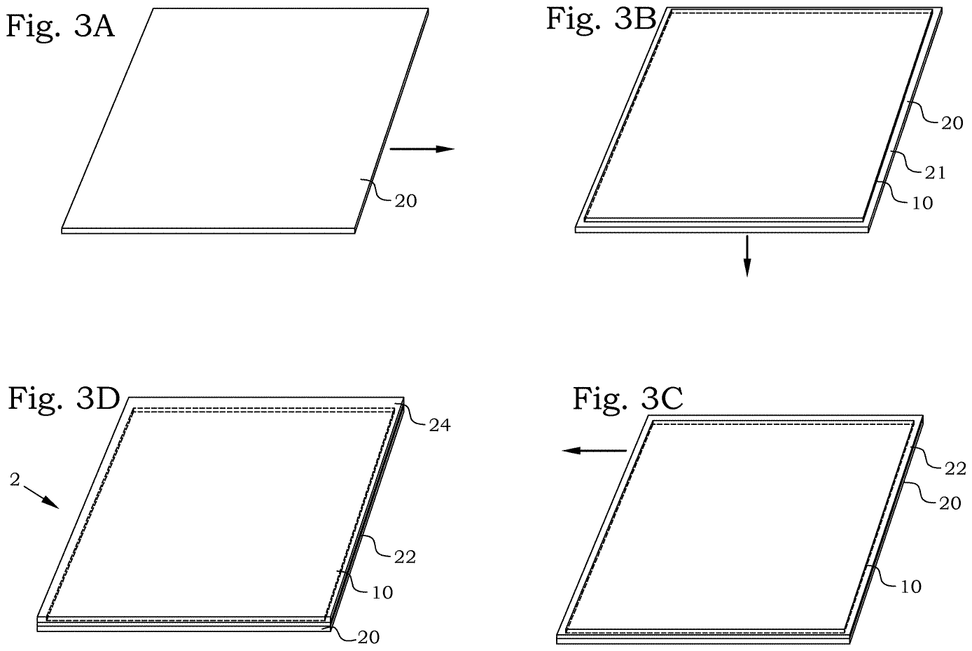

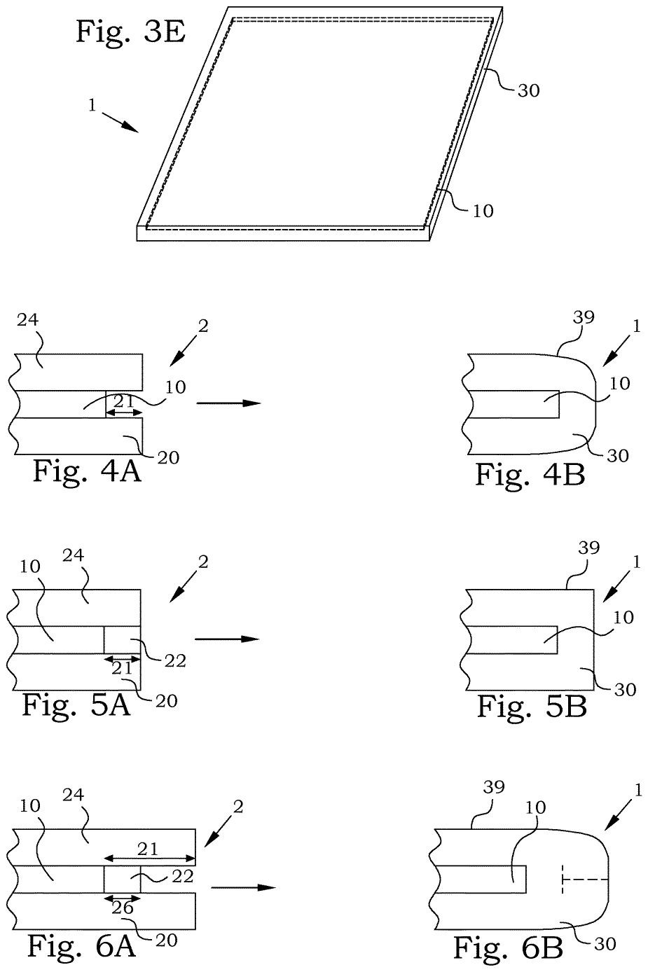

FIGS. 3A-3E illustrate schematically an embodiment of a method for producing a variable optical-property interlayer product. In FIG. 3A, a first lamination interlayer film 20 is provided. In FIG. 3B, a VOP film 10 has been placed on top of the first lamination interlayer film 20. In order to achieve a good sealing by the lamination interlayer materials, a margin 21 is preferably left between the edge of the VOP film 10 and the edge of the first lamination interlayer film 20. Therefore, in a preferred embodiment the step of placing the VOP film 10 on top of the first lamination interlayer film 20 comprises placing the VOP film 10 with a margin 21 of at least 10 mm to a nearest edge of the first lamination interlayer film 20.

In FIG. 3C, a lamination interlayer edge sealing 22 is placed onto the margin 21, thereby laterally encircling the VOP film 10. The lamination interlayer edge sealing is preferably of the same lamination interlayer material as the first lamination interlayer film. The lamination interlayer edge sealing 22 has preferably a thickness that is similar to the thickness of the VOP film 10, preferably within 20%. The upper surface of the arrangement presented in FIG. 3C is now almost flat all the way out to the outer rim of the lamination interlayer edge sealing 22. In this embodiment, the width of the lamination interlayer edge sealing 22 is equal to the margin 21. However, as will be discussed further below, the lamination interlayer edge sealing 22 may have another width, then typically smaller than the margin 21.

In FIG. 3D, a second lamination interlayer film 24 has been placed on top of the VOP film 10 and the lamination interlayer edge sealing 22. A stack 2 of a VOP film 10 provided between lamination interlayer films 20, 22, 24 is formed. The stack is exposed for a lamination process, in which the parts made of lamination interlayer material are caused to adhere to each other. As illustrated in FIG. 3E, the lamination causes a formation of a polymer envelope 30, encapsulating the VOP film 10. The encapsulated VOP film 10 and the polymer envelope 30 thereby constitute a variable optical-property interlayer product 1, suitable to be stored, transported and/or further laminated.

In other words, a variable optical-property interlayer product 1 comprises a VOP film 10 and a polymer envelope 30. The polymer envelope 30 gas-tightly encapsulates the VOP film. The polymer envelope 30 consists of a lamination interlayer material. An outer surface of the polymer envelope is a solid/gas interface.

In a preferred embodiment, with reference to FIGS. 3A-E, the polymer envelope 30 comprises a first lamination interlayer film 20 and a second lamination interlayer film 24 provided at opposite sides of the VOP film 10. The polymer envelope 30 further comprises a lamination interlayer edge sealing 22 enclosing the VOP film 10 laterally and connecting the first lamination interlayer film 20 and the second lamination interlayer film 24.

FIG. 4A illustrates a part of a stack 2 of a first lamination interlayer film 20, a VOP film 10 and a second lamination interlayer film 24, but without lamination interlayer edge sealing. Upon lamination, the outer parts of the lamination interlayer films 20, 24 and possibly also an outer part of the VOP film 10 deforms in order to provide the polymer envelope. A possible result is schematically illustrated in FIG. 4B, where the polymer envelope 30 is formed. Such laminations are indeed possible to perform, in particular with lamination interlayer materials that achieve a low viscosity when being heated. However, the lamination process conditions have to be carefully controlled in order to minimize the risk for encapsulating gas volumes. The laminating 10 forms an outer surface 39 of the polymer envelope 30 as a solid/gas interface. In FIG. 5A, a stack 2 also comprising a lamination interlayer edge sealing 22 is illustrated. FIG. 5B illustrates schematically the result after lamination. The risks for encapsulating gas pockets and the risks for damaging the edges of the VOP film 10 are reduced compared to the embodiment of FIG. 4B.

In FIG. 6A, a stack 2 comprising a lamination interlayer edge sealing 22 is illustrated, but where the width 26 of the lamination interlayer edge sealing 22 is smaller than the margin 21. FIG. 6B illustrates schematically the result after lamination. The risks for encapsulating gas pockets in connection with the VOP film 10 is small and the risks for damaging the edges of the VOP film 10 are also reduced compared to the embodiment of FIG. 4B. The outermost parts of the lamination interlayer films 20, 24 protrudes outside the rim of the lamination interlayer edge sealing 22, which e.g. may be used for protecting electrical connections to the VOP film 10, as will be discussed below. Superfluous parts of the polymer envelope 30 are, however, easily cut to proper sizes in connection with a final glass lamination process.

The above principles are similar for at least most variable optical-property interlayer products. Electrochromic (EC) films are obvious choices. Other film-based technologies with variable optical properties, such as e.g. liquid-crystal displays (LCD), polymer-dispersed liquid crystal films (PDLC) or suspended particle devices (SPD), are also dependent on that the active films as well as the electrical connections are non-trivial to handle or process. If such VOP films are to be provided laminated between or behind glass plates, the same principles as above may be applied. Also other types of VOP films, such as thermochromic films or photochromic films, may be produced by the same principles.

In other words, in a preferred embodiment, the VOP film comprises an electrochromic film, a thermochromic film, a photochromic film, an LCD, a PDLC and/or an SPD.

In a most preferred embodiment, the variable optical-property film comprises an electrochromic film. Such an electrochromic film can also be of different kinds, as such known in prior art. Preferably, the electrochromic films are provided based on a flexible substrate, such as polymer films. This gives a possibility for slightly bending the electrochromic films without damaging the electrochromic function. An electrochromic film that has proven to be very advantageous in connection with glass lamination is a type comprising a layered film structure of a solid-electrochromic-layer provided between polymer films. Such electrochromic films are, as such, e.g. described in the European patent EP 3 011 388 B1 or in the published International patent application WO 2014/170241 A2.

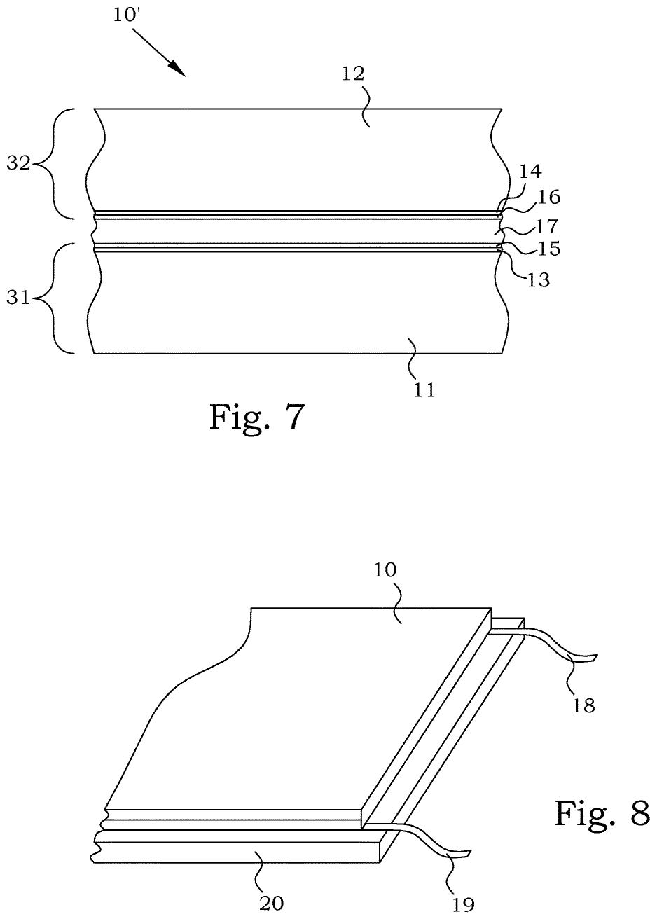

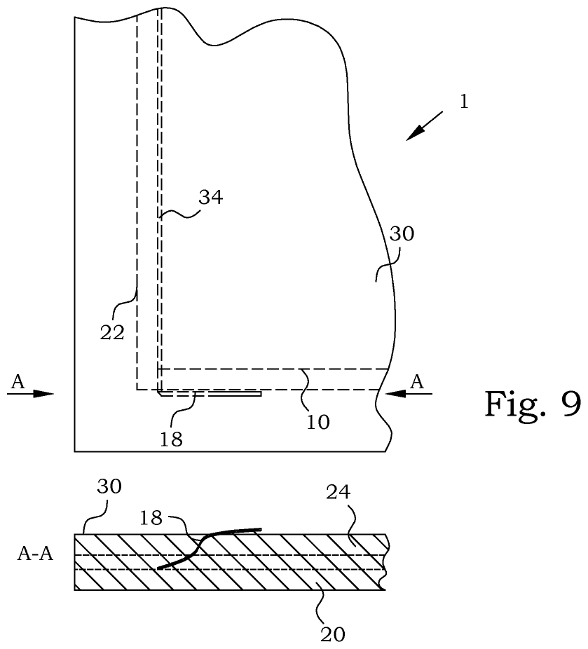

FIG. 7 illustrates schematically a part cross-sectional view of one embodiment of an electrochromic film 10′ possible to use according to the present technology. The electrochromic film 10′ comprises two half-cells 31, 32. Each half-cell 31, 32 comprises a respective substrate sheet 11, 12, made of polymer, a respective electron conducting layer 13, 14, and an electrochromic layer 15 or a counter electrode layer 16. In other words, one half-cell, in FIG. 7 the lower half-cell 31, of the laminated electrochromic layered structure comprises a first substrate sheet 11, made of polymer, a first electron conducting layer 13 at least partially covering the first substrate sheet 11, and a first electrochromic layer 15 at least partially covering the first electron conducting layer 13. The other half-cell, in FIG. 7 the upper half-cell 32, of the laminated electrochromic layered structure comprises a second substrate sheet 12, made of polymer, a second electron conducting layer 14 at least partially covering the second substrate sheet 12, and a counter electrode layer 16 at least partially covering the second electron conducting layer 14. An electrolyte layer 17 is laminated between and at least partially covering the first electrochromic layer 15 and the counter electrode layer 16. In one embodiment, the counter electrode layer 16 may in itself also be an electrochromic layer.

### However, Also Other Types of Electrochromic Films Can Be Used in Connection with the basic ideas presented here.

In order to operate many kinds of variable optical-property films, a voltage or other type of electrical signal has to be applied between parts of the VOP film. In the embodiment of FIG. 7, the first and second electron conducting layers 13, 14 are typically to be contacted. The processes for obtaining this are well-known as such in prior art and is therefore known by the person skilled in the art and will therefore not be further described, as such.

However, since the present technology provides a variable optical-property interlayer product that is intended to be contacted at a later stage, some aspects may be discussed. In a typical case, the VOP film is provided with connectors attached to conductive layers of the VOP film, according to processes, known as such in prior art. FIG. 8 illustrates such an VOP film 10, having a first connector 18 and a second connector 19. The step of placing the VOP film 10 on top of a first lamination interlayer film 20 is performed such that the ends of the connectors 18, 19 are placed outside the edge of the first lamination interlayer film 20 and later also outside the edge of the second lamination interlayer film. During lamination, the connectors will be embedded into the lamination interlayer material, but will still be available and contactable from outside the polymer envelope.

In embodiments utilizing a lamination interlayer edge sealing and where the VOP film is provided with connectors attached to conductive layers of the VOP film, it is preferred that the step of laterally encircling the VOP film further comprises placing ends of the connectors outside at least the lamination interlayer edge sealing.

One such embodiment is illustrated schematically in FIG. 9. Here bus bars 34 of the VOP film 10, being in electrical contact with electrically conducting layers within the VOP film 10, are extended as a connector 18 that will protrude outside the lamination interlayer edge sealing 22. The connector 18 is bent 90 degrees outside the lamination interlayer edge sealing 22. The end of the connector 18 will therefore upon the lamination be situated in the space between the protruding parts of the lamination interlayer films 20, 24, as seen in the cross-sectional view A-A at the bottom of the figure. By cutting an opening through e.g. the second lamination interlayer film 24, the connector 18 may be stuck through that hole and become available at the top surface of the polymer envelope 30.

In other words, in one embodiment of the variable optical-property interlayer product, the variable optical-property interlayer product comprises connectors attached to conductive layers of the VOP film, wherein the connectors penetrate the polymer envelope.

The actual lamination may be performed in many different ways. In one embodiment, the step of laminating the stack is performed by conveying the stack between heated lamination nip rolls. This is often referred to as “pre-lamination” and is often used in as a preparation step before a regular lamination process e.g. in an autoclave for assisting in removing air between the lamination interlayer and surrounding material. By selecting lamination interlayer materials, temperatures and conveying speed properly, such “pre-lamination” may in fact be enough for producing the polymer envelope according to the above ideas. Since the use of nip rolls in glass lamination involves glass panes between the lamination interlayer and the nip rolls, the heat transfer is relatively slow. When using nip rolls directly onto the lamination interlayer materials, the heat transferred from the rolls may be enough for causing the polymer envelope to form. However, the process conditions have to be controlled very carefully.

The lamination may also be performed in an autoclave, in a vacuum laminator or just in a heated vacuum bag.

In other words, in one embodiment, the step of laminating the stack is performed as a vacuum lamination.

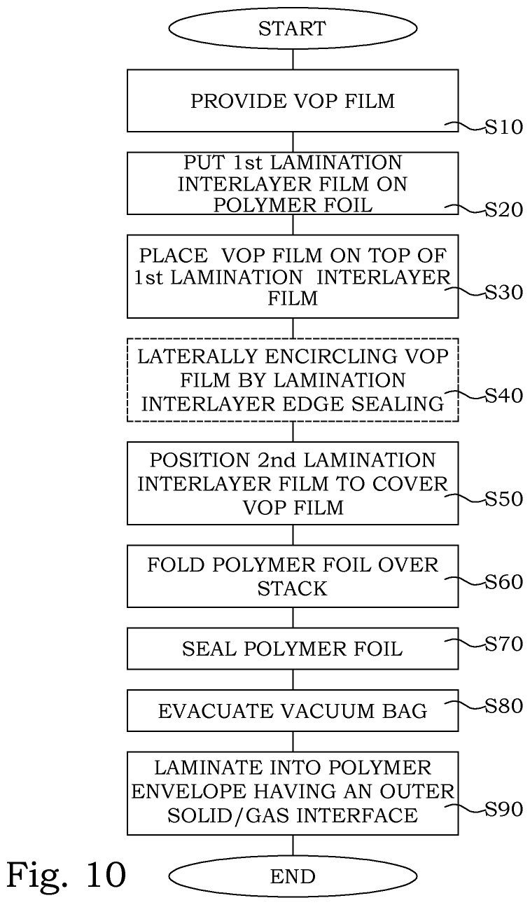

The use of vacuum bags may be advantageous in some respects. FIG. 10 illustrates a flow diagram of steps of an embodiment of a method for producing a variable optical-property interlayer product using vacuum bags. Steps in common with earlier embodiments are not discussed in detail again. In step S20, the first lamination film is put onto a polymer foil intended to form the vacuum bag. The foil is at least twice the size of the VOP film. The stack is then formed in the same way as described above. In step S50, a free part of the polymer foil is folded over the top of the stack, and in step S60, the polymer foil is sealed into a bag. This may be performed using e.g. butyl tapes or by welding. A valve is also mounted in the bag, allowing for attaching a vacuum pump. In step S80, the vacuum bag is evacuated. This evacuation causes the stack to be pressed together with the atmospheric pressure and any gas remaining between the VOP film and the lamination interlayer films is removed. The stack is then ready for lamination by increasing the temperature.

In other words, in one embodiment, the method for producing a variable optical-property interlayer product comprises putting of the first lamination interlayer film on top of a first part of a polymer foil. After the step of positioning the second lamination interlayer film, a second part of the polymer foil is folded over the stack. The second part is sealed to the first part, thereby creating a vacuum bag enclosing the stack. The vacuum bag is evacuated. The step of laminating the stack then comprises heating the vacuum bag.

The lamination may e.g. be performed in an autoclave or an oven or simply by increasing a surrounding temperature in some other controllable way. When the lamination is ready, the vacuum bag may be removed. Due to the limited temperature, the vacuum bag is not at least fully laminated to the lamination interlayer films and are easily removed.

In this context, there is also a benefit of letting parts of the vacuum bag to remain as an additional protective layer. By e.g. removing the vacuum valve and possibly also the butyl tapes, a thin additional protectional layer is provided around the variable optical-property interlayer product that is easily removed before a final lamination.

In other words, in one embodiment, a packaged variable optical-property interlayer product comprises a variable optical-property interlayer product according to the description above and a vacuum bagging film enclosing the variable optical-property interlayer product. Preferably, the vacuum bagging film comprises a polymer.

One unwanted aspect of the use of vacuum bags is that there are a lot of processing steps introduced, which are made in an item-by-item fashion. For large processing series, this may be non-efficient. Another approach is to use reusable vacuum rubber bags. In one preferred embodiment, a protective polymer film is provided as a separate part of the vacuum bag assembly and is provided between the rubber material and the lamination interlayer films. This typically facilitates the removal of the laminated polymer envelope out from the vacuum bag. This protective polymer film may also be allowed to follow the laminated product as the vacuum bagging film, described here above, improving the laminated polymer envelope protection.

Yet another approach that may be attractive is to let the step of laminating the stack comprise a processing of the stack in a vacuum laminator.

In vacuum laminator, an object to be laminated, in this case the stack of lamination interlayer films and the VOP film, is introduced into a heated vacuum compartment by means of a conveyor system, e.g. a transport belt. The temperature of the compartment may be kept at approximately the requested lamination temperature. The compartment is sealed off and evacuated. Such a procedure takes in a typical case half a minute if high performance pumps are used. A vacuum tight membrane is placed on top of the stack to be laminated and gas, preferably heated to the lamination temperature, is allowed to enter the compartment above the membrane, which presses the membrane against the stack. If normal atmospheric pressure is applied, the pressure on the stack will be comparable with what is achieved in a vacuum bag. If higher pressures are requested, a pressurized gas could be entered above the membrane. The evacuation and the pressure forces remove any gas between the lamination interlayer films and the VOP film. The heat in the vacuum laminator will cause the lamination to take place. Such a procedure takes in a typical case half a minute to a couple of minutes, depending on the temperature and choice of lamination interlayer material.

As briefly mentioned above, use of a high temperature may affect the surface structure of the polymer envelope. The lamination interlayer films are typically presenting some sort of structures within the surface, which is intended to assist in an intended later lamination process. Such structures may e.g. reduce capillary forces when the lamination interlayer films are placed on e.g. glass panes and they may also assist in removing any air from the space between the lamination interlayer films and the surfaces to which they are to be laminated. If relatively high temperatures are used in the lamination of the present technology, such lamination interlayer film surface structures may be influenced and even removed.

In such a situation, the lamination step could additionally comprise the formation of “new” surface structures. This can easily be achieved by supplying the support surface, to which the outer surface of the envelope is in contact, with appropriate structuring. When the lamination interlayer film softens during the lamination, it will assume the same structure as the support surface.

For instance, if using a vacuum bag, reusable or not, the material used for forming the bag or a particular structure sheet could be provided with a requested pattern. By placing the outer surfaces of the lamination interlayer films to support against these structured support surfaces, the atmospheric pressure will, when the vacuum bag in evacuated, press the surfaces against each other, giving the requested structuring.

Likewise, in a vacuum laminator, the conveyor for the stack and the membrane could be provided with appropriate structuring, which will be embossed into the outer surface of the polymer envelope. The conveyor and the membrane will thereby have the function of a support surface in analogy of the vacuum bag approach.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method for producing an interlayer product having variable optical properties, comprising the steps of:
providing a variable optical-property film;
placing said variable optical-property film on top of a first lamination interlayer film of a lamination interlayer material;
positioning a second lamination interlayer film of a lamination interlayer material covering said variable optical-property film, forming a stack;
laminating said stack forming a polymer envelope gas-tightly encapsulating said variable optical-property film;
wherein said step of laminating forms an outer surface of said polymer envelope as a solid/gas interface.

2. The method according to claim 1, comprising the further step of, between said placing step and said positioning step:
laterally encircling said variable optical-property film by a lamination interlayer edge sealing of a lamination interlayer material;
wherein said polymer envelope is formed by said first lamination interlayer film, said second lamination interlayer film and said lamination interlayer edge sealing

3. (canceled)

4. (canceled)

5. The method according to claim 1, wherein said step of laminating is performed at a temperature causing intra-lamination between said lamination interlayer material.

6. The method according to claim 5, wherein said step of laminating is performed at a temperature leaving said outer surface of said polymer envelope structurally unchanged.

7. (canceled)

8. The method according to claim 1, wherein said step of placing said variable optical-property film on top of said first lamination interlayer film comprises placing said variable optical-property film with a margin of at least 10 mm to a nearest edge of said first lamination interlayer film.

9. The method according to claim 1, wherein said variable optical-property film is provided with connectors attached to conductive layers of said variable optical-property film, wherein said step of placing said variable optical-property film on top of a first lamination interlayer film further comprise placing ends of said connectors outside said first lamination interlayer film and said second lamination interlayer film.

10. The method according to claim 2, wherein said variable optical-property film is provided with connectors attached to conductive layers of said variable optical-property film, wherein said step of laterally encircling said variable optical-property film further comprises placing ends of said connectors outside said lamination interlayer edge sealing.

11. The method according to claim 1, wherein said step of laminating said stack is performed as a vacuum lamination, and
wherein the method further comprises the steps of:
putting said first lamination interlayer film on top of a first part of a polymer foil;
folding, after said step of positioning said second lamination interlayer film, a second part of said polymer foil over said stack;
sealing said second part to said first part, thereby creating a vacuum bag enclosing said stack; and
evacuating said vacuum bag;
and wherein said step of laminating said stack comprises heating said vacuum bag.

12. (canceled)

13. The method according to claim 1, wherein said step of laminating said stack is performed as a vacuum lamination, and wherein said step of laminating said stack comprises processing said stack in a vacuum laminator.

14. The method according to claim 1, wherein said step of laminating said stack is performed by conveying said stack between heated lamination rolls.

15. (canceled)

16. (canceled)

17. (canceled)

18. A variable optical-property interlayer product, comprising:
a variable optical-property film; and
a polymer envelope, gas-tightly encapsulating said variable optical-property film;
said polymer envelope consisting of a lamination interlayer material;
wherein an outer surface of said polymer envelope being a solid/gas interface.

19. The variable optical-property interlayer product according to claim 18, wherein said polymer envelope comprises a first lamination interlayer film and a second lamination interlayer film provided at opposite sides of said variable optical-property film and wherein said polymer envelope further comprises a lamination interlayer edge sealing enclosing said variable optical-property film laterally and connecting said first lamination interlayer film and said second lamination interlayer film.

20. The variable optical-property interlayer product according to claim 18, wherein said lamination interlayer material is selected as at least one of:
Polyvinyl butyral,
Ethylene Vinyl Acetate,
Polyolefin,
Thermoplastic polyurethane, and
Ionoplasts.

21. The variable optical-property interlayer product according to claim 20, wherein said lamination interlayer material is Polyvinyl butyral.

22. The variable optical-property interlayer product according to the claim 18, wherein said variable optical-property film comprises at least one of:
an electrochromic film,
a thermochromic film,
a photochromic film,
a liquid-crystal display,
a polymer-dispersed liquid crystal film, and
a suspended particle device.

23. The method according to claim 22, wherein said variable optical-property film comprises an electrochromic film.

24. The variable optical-property interlayer product according to claim 23, wherein said electrochromic film comprises a layered film structure of a solid-electrochromic-layer provided between polymer films.

25. The variable optical-property interlayer product according to claim 18, further comprising connectors attached to conductive layers of said variable optical-property film wherein said connectors penetrate said polymer envelope.

26. A packaged variable optical-property interlayer product, comprising:
a variable optical-property interlayer product according to claim 18; and
a vacuum bagging film at least partly enclosing said variable optical-property interlayer product.

27. The packaged variable optical-property interlayer product according to claim 26, wherein said vacuum bagging film comprises a polymer.
